(19) United States
(12) Patent Application Publication
(10) Pub. No.: US 2014/0000082 A1
(43) Pub. Date: Jan. 2, 2014

(54) Razor Blade Technology

(71) Applicant: Eveready Battery Company Inc., St Louis, MO (US)

(72) Inventor: Yiming Xu, Milford, CT (US)

(21) Appl. No.: 13/920,498

(22) PCT Filed: Dec. 7, 2011
(86) PCT No.: PCT/US11/63699

§ 371 Date: Sep. 17, 2013

Related U.S. Application Data
(60) Provisional application No. 61/430,294, filed on Jan. 6, 2011.

(51) Int. Cl. B26B 21/40

(52) U.S. Cl. CPC B26B 21/4068
USPC 29/423

(57) ABSTRACT

An inter-blade guard of a suitably ductile material for a razor cartridge is provided with an elongated weakened region. The weakened region is provided after the inter-blade guard is attached to a surface of a razor blade. The weakened region is provided by the application of laser energy that forms a groove along a side of the inter-blade guard. The root region of the groove undergoes intergranular carbide precipitation to locally embrittle the intergranular boundary regions in the groove root region of the otherwise ductile material.

### CROSS REFERENCE TO RELATED APPLICATIONS

This application claims the benefit of International Application PCT/US2011/063699, filed Dec. 7, 2011 which claims the benefit of U.S. provisional patent application Ser. No. 61/430,294, filed Jan. 6, 2011, the contents of both are incorporated herein for reference in their entirety.

### BACKGROUND

1. Technical Field

This disclosure relates generally to manufacturing processes for razor blades, and more specifically to methods of imparting a weakened region to inter-blade guards for razor blades.

2. Background

Many modern safety razors include a disposable razor cartridge adapted to be selectively connected to a reusable handle by connecting structure therebetween. The cartridge includes a housing having at least one razor blade with a sharpened cutting edge disposed therein. Other modern safety razors include a razor cartridge permanently connected to the handle that can be disposed of as a single unit.

In commonly assigned U.S. Pat. No. 7,681,314, benefits of providing a razor cartridge with an inter-blade guard are disclosed. In a commercialized embodiment of a razor cartridge including an inter-blade guard, sold under the trade name HYDRO by the assignee of the present disclosure, an inter-blade guard is attached to an upper surface of a razor blade. To provide access for attaching (e.g. laser welding) the inter-blade guard to its razor blade the inter-blade guard is provided partially formed. After attachment the inter-blade guard is further formed. The inter-blade guard is also provided with an integral removable portion provided to aid handling during manufacture of the inter-blade guard up to and including the step of attachment of the inter-blade guard to its razor blade. The removable portion of the inter-blade guard is then severed, e.g. broken from the portion of the inter-blade guard attached to the razor blade. A dilemma subsequently exists in the manufacturing method of the inter-blade guard. The material of the inter-blade guard should be suitably ductile such that the forming after attachment does not cause cracks the inter-blade guard material. On the other hand the material should be suitably brittle to facilitate severing the removable portion.

### SUMMARY

The present disclosure has for its objective to eliminate, or at least substantially alleviate the limitations of the prior art manufacturing processes for inter-blade guards. The disclosure is directed particularly to a method of manufacturing an inter-blade guard attached to a razor blade, the inter-blade guard having a suitably weakened region. The method comprises the steps of:
a) providing a razor blade having an upper surface;
b) attaching an at least partially formed inter-blade guard to the upper surface, the inter-blade guard having an attachment portion and a removable portion;
c) weakening the inter-blade guard in a region of the inter-blade guard between the attachment portion and the removable portion after the step of attaching the inter-blade guard to the upper surface; and

d) removing the removable portion of the inter-blade guard.

In some embodiments the step of weakening the inter-blade guard is performed by providing an elongated groove in the region of the inter-blade guard between the attachment portion and the removable by an application of laser energy. The root of the groove preferably undergoes intergranular carbide precipitation. The material of the inter-blade guard is preferably a low carbon austenitic stainless steel having an elongation at break greater than 10%, more preferably greater than 20%.

Embodiments of the disclosure have the following advantages. The process to provide the weakened region is performed after the inter-blade guard is attached to a razor blade. If the weakened region is provided in an earlier process step the weakened region should be sufficiently robust to withstand process steps up to and including attachment of the inter-blade guard to a razor blade. In the present process the weakened region can beneficially be less robust. Local modification of the microstructure of the inter-blade guard to provide intergranular carbide precipitation tends to partially embrittle the root of the groove in a preferably ductile material further facilitating removal of the removable portion of the inter-blade guard.

These and other features and advantages of the present disclosure will be more fully understood with reference to the following detailed description when taken in conjunction with the accompanying drawings.

### BRIEF DESCRIPTION OF THE DRAWINGS

FIG. 1 is a schematic sectional view of a razor cartridge including an inter-blade guard.

FIG. 2A is an end view of a partially formed inter-blade guard.

FIG. 2B is an end view of the inter-blade guard of FIG. 2A mounted on a razor blade.

FIG. 2C is a perspective view of the arrangement of FIG. 2B undergoing a weakening process.

FIG. 2D is an end view of the arrangement of FIG. 2B after the process of FIG. 2C.

FIG. 2E is an enlarged schematic view of a portion of FIG. 2C.

FIG. 3 is an end view of another embodiment of an inter-blade guard mounted on a razor blade.

### DETAILED DESCRIPTION

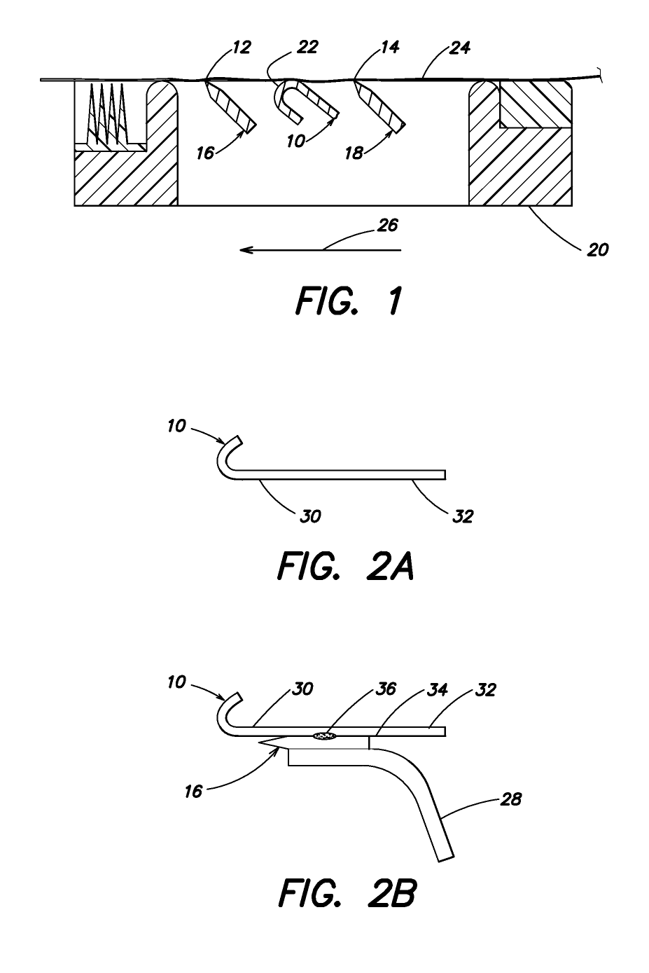

Referring now to the drawings and in particular to FIG. 1, in the context of the present disclosure, an inter-blade guard 10 defines structure disposed between adjacent cutting edges 12, 14 of respective razor blades 16, 18 mounted in a housing 20 of a razor cartridge. The inter-blade guard includes a surface 22 adapted to contact the skin surface of a user 24 during normal use of the razor cartridge after a preceding cutting edge and before a following cutting edge when the razor cartridge is drawn in the direction of arrow 26.

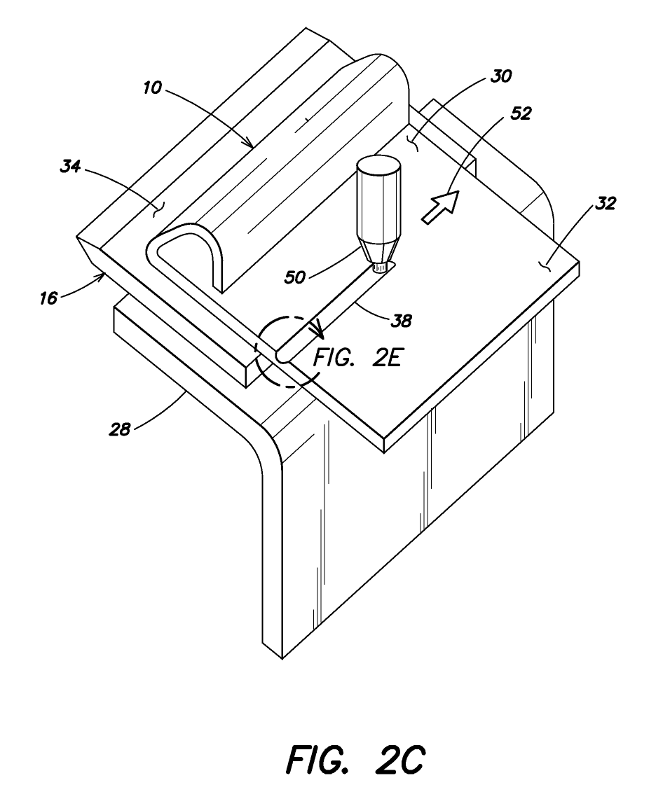

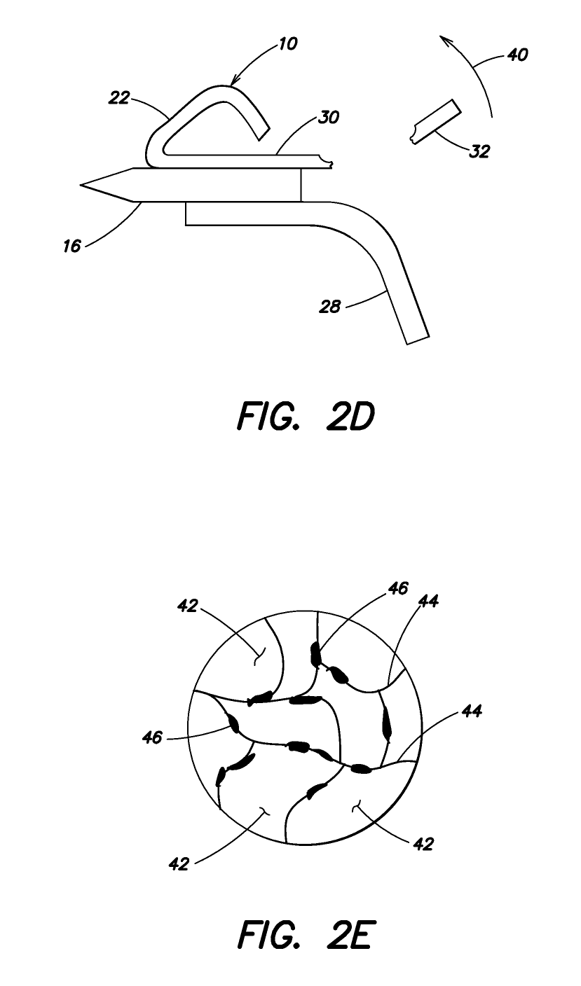

Referring now to FIGS. 2A-2E, in one exemplary embodiment, the inter-blade guard 10 is provided partially formed in e.g. a toboggan shape when viewed from an end thereof. The inter-blade guard has an attachment portion 30 and a removable portion 32. The removable portion is provided to facilitate handling the inter-blade guard up to and during assembly of the inter-blade guard to its razor blade and is subsequently removed. The inter-blade guard is attached to an upper surface 34 of razor blade 16. Razor blade 16 can be attached to a blade support 28, e.g. an “L” shaped blade support as is known in the art. The inter-blade guard can be attached e.g. by laser welding to provide a weld region 36. The front curved end of the toboggan shape is then further formed to provide a surface that will eventually becomes a skin contacting surface 22 during use as described above (see FIG. 2D). The inter-blade guard is weakened in a region between the attachment portion and the removable portion. Preferably the weakened region is provided by an elongated groove 38 in the inter-blade guard caused by the application of laser energy by laser emitter 50 that makes one or more passes along the inter-blade guard in direction 52 and its reverse. Most preferably the laser energy is controlled as described below to further cause intergranular carbide precipitation in the vicinity of the root of the groove. In FIG. 2E, microstructure of the root of the groove is depicted schematically. Grains 42 have boundaries 44. During heating and subsequent cooling of this region, carbides 46 precipitate at the grain boundaries. This precipitation partially embrittles the intergranular boundary region(s) of the structure providing fracture initiation sites when the removable portion is removed. The removable portion 32 is then removed, e.g. by bending the removable portion in the direction of arrow 40. The razor blade with its inter-blade guard is mounted in a housing to provide a razor cartridge.

As the inter-blade guard is further formed after attachment to a razor blade the material for the inter-blade guard is preferably relatively ductile, such that the further forming does not create cracks, especially in the skin engaging surface. Preferably the material of the inter-blade guard is unannealed AISI 301 grade austenitic stainless steel having a thickness about 0.075 mm. This material has an elongation at break at least about 10% and a yield strength at least about 1000-1200 MPa. More preferably the material is fully or partially annealed AISI grade 301 stainless steel having an elongation at break at least about 20% and a yield strength about 930-1000 MPa. Other suitable materials can also be employed.

A suitable laser emitting device is a model LMF5000 fiber laser marking system provided by UNITEK MIYACHI. Suitable operating parameters for this device include operating power 40%-100% (of peak power 50W); frequency 5-100 kHz; laser spot size in the range 0.035 to 0.050 mm; linear speed along the inter-blade guard in the range 120 to 350 mm/s. The laser spot can be focused at the outer surface of the inter-blade guard or can be focused below the outer surface, e.g. 0.025-0.050 mm below the surface. One or more passes along the inter-blade guard can be made. As basis of the inter-blade guard weakening process is to facilitate removal of a removable portion thereof, laser energy can be used to cut entirely through the inter-blade guard. However, this is not preferred as suitable masking has then to be provided on the opposed side of the inter-blade guard to prevent the laser energy in turn affecting the razor blade and/or its support and/or the nest or surrounding area of the processing equipment. Preferably the depth of the groove is up to about ⅔ the thickness of the inter-blade guard. As previously mentioned, the laser energy is preferably controlled such that heating of the inter-blade guard and subsequent cooling of the material of the root region of a subsequently formed groove undergoes intergranular carbide precipitation to locally embrittle the intergranular boundary regions in the groove root region of an otherwise ductile material.

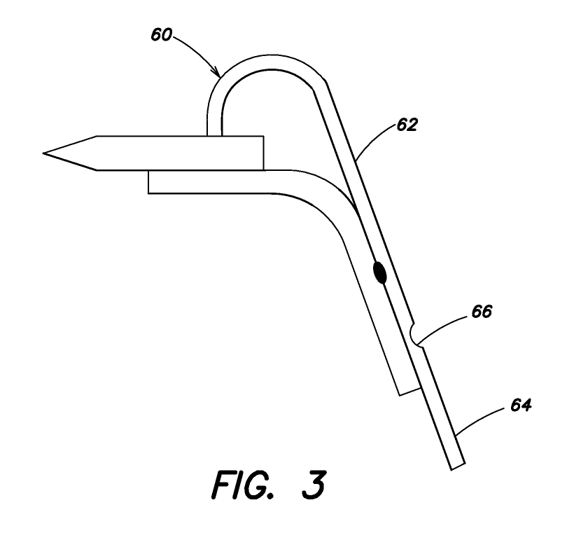

Referring now to FIG. 3, in other embodiments the inter-blade guard 60 can be fully formed when it is attached to a razor blade. The inter-blade guard comprises an attachment portion 62 and a removable portion 64 as previously described. A weakened region 66 is provided and the removable portion 64 is removed also as previously described.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. For instance, features disclosed in connection with any one embodiment can be used alone or in combination with each feature of the respective other embodiments.

What is claimed is:

1. A method of manufacturing an inter-blade guard for a razor cartridge, comprising the steps of:
a) providing a razor blade having an upper surface;
b) attaching an at least partially formed inter-blade guard to the upper surface, the inter-blade guard having an attachment portion and a removable portion;
c) weakening the inter-blade guard in a region of the inter-blade guard between the attachment portion and the removable portion, wherein this step is performed after the inter-blade guard is attached to the upper surface; and
d) removing the removable portion of the inter-blade guard.

2. The method of claim 1, wherein the inter-blade guard comprises austenitic stainless steel.

3. The method of claim 1, wherein the step of weakening the inter-blade guard is performed by providing an elongated groove in an upper surface of the inter-blade guard in the region of the inter-blade guard between the attachment portion and the removable portion.

4. The method of claim 3, wherein the groove has a depth up to two thirds of a thickness of the inter-blade guard.

5. The method of claim 3, wherein the groove is formed by an application of laser energy.

6. The method of claim 5, wherein a root region of the groove undergoes intergranular carbide precipitation.

7. The method of claim 2, wherein the austenitic stainless steel has an elongation at break greater than 10%.

8. The method of claim 2, wherein the austenitic stainless steel has an elongation at break greater than 20%.

9. The method of claim 5, wherein the laser energy is focused at the upper surface of the inter-blade guard.

10. The method of claim 5, wherein the laser energy is focused below the surface of the inter-blade guard.

11. The method of claim 10, wherein the laser energy is focused up to 0.05 mm below the surface of the inter-blade guard.
